(19) United States
(12) Patent Application Publication
(10) Pub. No.: US 2012/0118036 A1
(43) Pub. Date: May 17, 2012

(54) SYSTEM AND METHOD FOR REDUCING THE AMPLITUDE OF THERMALLY INDUCED VIBRATIONS IN MICROSCALE AND NANOSCALE SYSTEMS

(75) Inventor: Jason Vaughn Clark, Lafayette, IN (US)

(73) Assignee: Purdue Research Foundation, West Lafayette, IN (US)

(21) Appl. No.: 13/271,064

(22) Filed: Oct. 11, 2011

Related U.S. Application Data
(60) Provisional application No. 61/391,331, filed on Oct. 8, 2010.

(51) Int. Cl. G01L 25/00

(52) U.S. Cl. 73/1.08

(57) ABSTRACT

The present invention generally relates to a system and method for improving the precision and applicability of microscale and nanoscale electromechanical systems. The system includes a device (such as an electrostatic sensor) for measuring parameters of a force associated with noise-induced background readings of a microscale or nanoscale electromechanical system, and a device (such as an electrostatic actuator) for applying a countering force to the electromechanical system.

### CROSS REFERENCE TO RELATED APPLICATION

This application claims priority to U.S. Provisional Patent Application Ser. No. 61/391,331, entitled “SYSTEM AND METHOD FOR REDUCING THE AMPLITUDE OF THERMALLY-INDUCED VIBRATIONS IN MICROSCALE AND NANOSCALE SYSTEMS,” filed Oct. 8, 2010, the disclosure of which is hereby expressly incorporated by reference herein in its entirety.

### BACKGROUND

1. Field of the Disclosure.

The present disclosure relates to microscale and nanoscale electromechanical systems. More particularly, the present disclosure relates to a system and method for improving the precision and applicability of microscale and nanoscale electromechanical systems.

2. Description of the Related Art.

Microscale and nanoscale electromechanical systems, in general, are devices which integrate electrical and mechanical functionality on the micro or nano scale, respectively. For example, microscale and nanoscale electromechanical systems may integrate microscale or nanoscale electronics with a mechanical actuator, pump, and or motor. Current uses of microscale and nanoscale electromechanical systems include physical sensors, such as accelerometers, chemical sensors, such as mass spectrometers, and bio sensors utilized in electrophoresis machines.

Among the numerous benefits of microscale and nanoscale electromechanical systems, include the low costs, low power usage, reduced size, and integration capability. Additionally, microscale and nanoscale electromechanical systems offer great potential for aiding in the development and creation of new and improved medicines, materials, sensors, and devices through molecular-scale engineering. However, the high performance and great potential for microscale and nanoscale electromechanical systems is currently limited due to noise-induced background data values or readings which affect the precision of such systems. As such, noise-induced background has limited the applicability of microscale and nanoscale electromechanical systems.

### SUMMARY

The present invention generally relates to a system and method for improving the precision and applicability of microscale and nanoscale electromechanical systems. The system includes a device (such as an electrostatic sensor) for measuring parameters of a force associated with noise-induced background readings of a microscale or nanoscale electromechanical system, and a device (such as an electrostatic actuator) for applying a countering force to the electromechanical system.

According to an embodiment of the present disclosure, a method of improving the precision of an electromechanical system which includes a plurality of components and which analyzes a parameter of a sample is provided. The method includes the step of determining a first parameter of a first force, associated with noise of a first component of the electromechanical, system. The method also includes the step of applying a second force to a second component of the electromechanical system and then analyzing the parameter of the sample with the electromechanical system. In some embodiments of this method, the second force is a random white noise. In other configurations, the first and second parameters include at least one of frequency or amplitude and are substantially the same. In other embodiments, the second parameter is less than the first parameter.

In some embodiments, the electromechanical system of the method is a nanoscale system, while in other embodiments of the method, the electromechanical system is a microscale system. Further, some embodiments include the electromechanical system being a force sensor, while in other embodiments of the method, the electromechanical system is a displacement sensor.

According to some embodiments of the present disclosure, the electromechanical system is an atomic force microscope having a cantilever with a tip. In such embodiments, the cantilever may be first component, upon which the first force is determined. In still other embodiments, the cantilever may also be the second component upon which the second force is applied.

According to another embodiment an electromechanical system, for analyzing a parameter of a sample, having improved precision is provided. The electromechanical system includes a first and a second component; a means for sensing a first parameter of a first force associated with noise of the first component; and a means for applying a second force having a second parameter to a second component of the electromechanical system. In some configurations of the electromechanical system, the first component and the second component are the same component. In some configurations of the electromechanical system, the second force is random white noise. In other configurations, the first and second parameters include at least one of frequency or amplitude and are substantially the same.

In some embodiments, the electromechanical system is an atomic force microscope comprising a cantilever having a tip. According to some configurations of this embodiment of the electromechanical system, the cantilever is the first component. In some configurations, the cantilever is also the second component.

### BRIEF DESCRIPTION OF THE DRAWINGS

The above-mentioned and other features and advantages of this disclosure, and the manner of attaining them, will become more apparent and the disclosure itself will be better understood by reference to the following description of embodiments of the disclosure taken in conjunction with the accompanying drawings, wherein:

FIG. 1 is diagrammatic representation of an exemplary microscale or nanoscale electromechanical system, such as an atomic force microscope;

FIG. 2 is a graph demonstrating the reduction in noise-induced displacement upon application of a countering electrostatic force to a microscale atomic force microscope system;

FIG. 3 is a graph demonstrating the reduction in noise-induced energy (potential and kinetic) upon application of a countering electrostatic force to the microscale atomic force microscope system of FIG. 2;

FIG. 4 is a graph demonstrating the reduction in noise-induced velocity upon application of a countering electrostatic force to the microscale atomic force microscope system of FIG. 2;

FIG. 5 is a graph demonstrating the application of a random white noise disturbance applied to the microscale atomic force microscope system of FIG. 2 for generating the noise-induced background data values presented in FIGS. 2-4; and

FIG. 6 is a graph demonstrating the application of an electrostatic force feedback to the microscale atomic force microscope system of FIG. 2.

Corresponding reference characters indicate corresponding parts throughout the several views. The exemplifications set out herein illustrate exemplary embodiments of the disclosure and such exemplifications are not to be construed as limiting the scope of the disclosure in any manner.

### DETAILED DESCRIPTION

Introduction.

The present invention generally relates to a system and method for improving the precision and applicability of microscale and nanoscale electromechanical systems. The system includes a device (such as an electrostatic sensor) for measuring parameters associated with noise-induced background, such as noise-induced vibrations, of an electromechanical device, and a device (such as an electrostatic actuator) for applying a countering force to the electromechanical system.

Microscale and Nanoscale Electromechanical Systems.

Microscale and nanoscale electromechanical systems (hereinafter “M/NEMS”) integrate electrical and mechanical functionality on the micro and nano scale, respectively. Microscale electromechanical systems include critical structural elements at the micrometer length scale, whereas nanoscale electromechanical systems comprise critical structural elements at or below 100 nanometers (nm).

M/NEMS are useful in the fields of force sensors, chemical sensors, biological sensors, and ultrahigh-frequency resonators, for example. Compared to larger scale systems, M NEMS comprise a smaller mass and have a higher surface area to volume ratio. The high surface area to volume ratio (combined with the small mass) makes M/NEMS particularly suited for applications regarding resonators and sensors. Examples of M/NEMS include (micro and nano) resonators, (micro and nano) accelerometers, and piezoresitive detection devices, for example.

When engineering M/NEMS, adequate computer aided design/engineering tools and metrology (the science of measurement) tools are needed. For example, scientists may discover a new nanoscale phenomenon and attempt to utilize the newly discovered nanoscale phenomenon in a nanoscale system. In order to do so, however, the discovered phenomenon must be understood. A theory regarding the phenomenon, based on the physics understood at the time, may be developed. The theory is then attempted to be matched with experimental results and observed parameters (based on metrology). Computer models of the phenomenon may also be developed along the way to aide in the understanding of the phenomenon. Devices incorporating M/NEMS, such as an atomic force microscope (hereinafter “AFM”), provide useful metrology tools which aide scientists in analyzing various microscale and nanoscale parameters such as force, velocity, frequency, amplitude, and displacement.

AFM, which is sometimes also referred to as scanning force microscopy, comprises an exemplary M/NEMS. AFM systems provide a valuable tool for use in imaging, measuring, and manipulating matter at the micro and nanoscale. Such systems provide a very high-resolution form of scanning probe microscopy which is able to detect stresses, vibrations, forces at the atomic level, and chemical signals, for example. Very generally, AFM systems can detect information relating to a sample by mechanically probing the surface of the sample or by detecting electric potentials between a sample and a component of the AFM system (for example, when using a conducting cantilever). Further, AFM systems may also probe electrical conductivity of a sample by passing currents through the tip of the cantilever.

AFM systems are capable of measuring forces on the order of tens of pico-Newtons (similar to the force necessary to rupture DNA), being used as a positioner, and being used to measure displacements on the order of tenths of nanometers (similar to the size of atoms). Further, a conventional AFM can measure forces to a level of about a hundredth of a nano-Newton (which is similar to the approximate gravitational force between two 1 kg masses 1 m apart (10⁻¹¹ N)). For the purposes of comparison, when measuring force, a conventional mass balances can measure forces to a level of about a micro-Newton (10⁻⁶N), which is illustratively equivalent to solar radiation per m² near earth. To facilitate a better understanding, and for comparison purposes, exemplary ranges of force measurement precision is illustratively presented below.

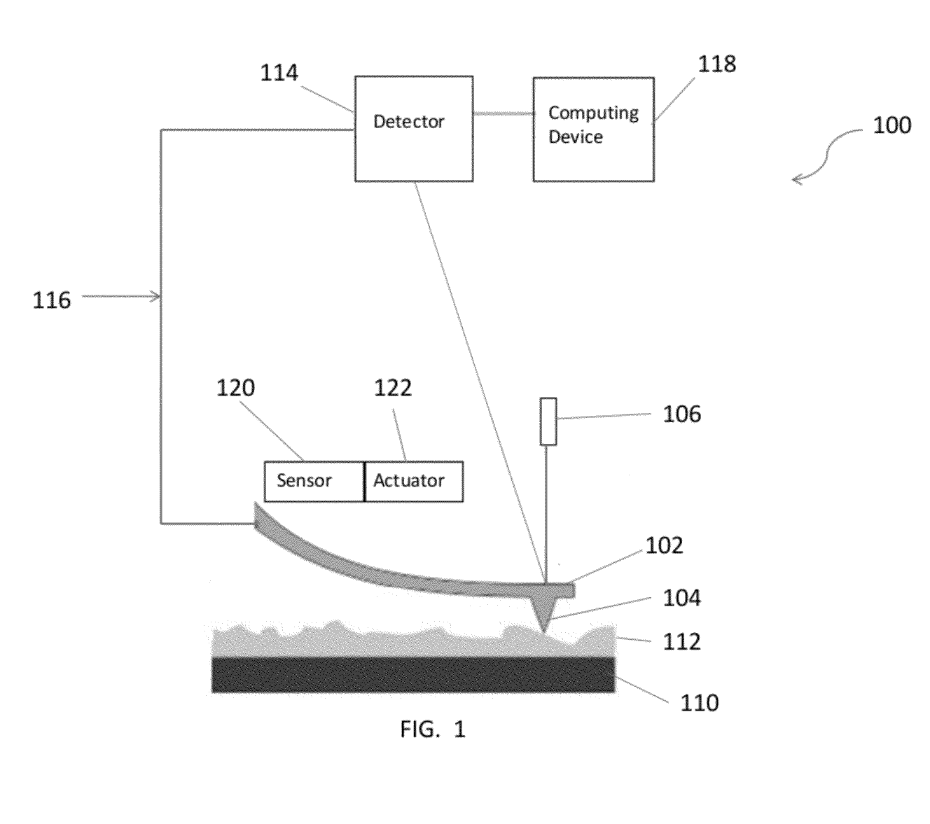

Referring to FIG. 1, an exemplary electromechanical system according to the instant disclosure, shown here as an AFM system (illustratively presented as system 100) is presented. As shown in FIG. 1, system 100 includes cantilever 102 having tip 104, laser 106, piezoelectric scanner 110 for moving sample 112, position sensitive photodiode detector 114, feedback loop 116, and computing device 118 which performs data acquisition, display and analysis. In use, tip 104 may be “dragged” over the surface of sample 112 by way of movement of scanner 110 (in a static mode described below), or cantilever 102 may be oscillated at, or close to, its fundamental resonance frequency while sample 112 is moved by scanner 110.

According to some embodiments of exemplary system 100, illustrated in FIG. 1, when tip 104 (of cantilever 102) is brought into proximity with the surface of sample 112, cantilever 102 is deflected according to Hooke's law, for example. In a static mode, cantilever 102 may be deflected by the mechanical contact force of tip 104 touching sample 112. In a dynamic mode, cantilever 102 may be deflected by an interaction force between the surface of sample 112 and tip 104 (of cantilever 102) such as a van der Waals force, magnetic force, or electrostatic force, for example.

As illustrated in FIG. 1, the deflection of cantilever 102 may be measured using laser 106, although any known method for measuring deflection may be utilized (such as strain gauges, for example). As shown, a beam from laser 106 is reflected off of the top of cantilever 102 and into photodiode detector 114, where parameters such as tip height and sample surface parameters are analyzed and calculated for providing adjustments to cantilever 102 through feedback mechanism 116 in order to prevent tip 104 from damaging the surface of sample 112. Further, data collected by photodiode detector 114, is communicated to computer 118 which performs the data analysis and displays the data.

Additionally, as shown in FIG. 1, sample 112 is mounted on piezoelectric scanner 110 which moves sample 112. In some configurations, scanner 110 may move sample 112 in any of the x, y, and z directions. In other configurations, scanner 110 may include the ability to move sample 112 in a vertical direction. Further, although shown as a single structure, scanner 110 may comprise more than one component, such as a three-part piezoelectric tube which can move sample in each of the x, y, and z directions.

In operation, AFM systems function in one of two primary modes: a static mode, and a dynamic mode. Very generally, the static mode involves measuring the deflection of a cantilever when dragging the tip (of the cantilever) across the surface of the sample. In the dynamic mode, a cantilever is oscillated at, or close to, its fundamental resonance frequency. The frequency (and or amplitude of the cantilever) is altered by interaction forces such as, van der Waals forces, dipole-dipole interaction, and electrostatic forces, for example, between the tip of the cantilever and the sample. There are various methods of measuring sample parameters using either static or dynamic mode, such as contact mode, non-contact mode, tapping mode, and cantilever deflection measurements (including vibration measurements). AFM systems may also perform force spectroscopy (i.e., measuring the interaction forces between a sample and the tip of a cantilever) and imaging, as well as and manipulation of the atoms and structures on the surface of the sample.

While M/NEMS, according to the instant disclosure, have been exemplified herein in the context of embodiments of AFM systems comprising a cantilever, the principles and teachings of the instant application are applicable to other M/NEMS systems known in the art for detecting and analyzing sample parameters. For example, the principles and teachings of the instant application may be utilized with nano-manipulator systems, nano-gripper systems, as well as data storage readwrite probe systems.

Precision and Applicability of Microscale and Nanoscale Electromechanical Systems.

Although, as mentioned above, M/NES offer numerous benefits and great potential in several fields, the applicability of M/NEMS devices has been limited due to non-specific background noise, such as noise-induced vibrations, for example. “Noise,” as used herein, refers to any non-sample created data readings which are detectable by the M NEMS devices. For example, “noise” may include background interference, environmental noise, and instrument-inherent noise which are detected by the instrument in a form of energy or force parameters. For example, noise may be detected as a frequency reading, displacement reading, amplitude reading, and potential and kinetic energy reading, for example.

Noise may also come from various sources. For example, exemplary sources of noise include random fluctuations in temperature, Johnson noise (due to random motion of charged carriers in resistive elements causing effective random voltages), Brownian motion noise (due to the fluidic molecular agitation of the surrounding atmosphere), surface contamination and outgassing (due to absorption and desorption of atmospheric contamination which effectively ages M/NEMS devices), 1/f noise, noise in the sustaining circuitry, stray capacitive noise, self heating noise, and drive power noise, etc., for example.

In macroscale systems, the noise described above does not present a significant impact on precision. However, as the dimensions of the critical structural elements comprising M/NEMS approaches micro and nano scale in size, such noise becomes significant and capable of causing instability in the utility and precision of the systems. Because such noise may have a significant impact on the stability and precision of M/NEMS devices, the ability of expanding the applicability of such devices depends, in part, on improving the precision of such systems by eliminating noise.

According the instant disclosure, a system for reducing or eliminating noise readings affecting the precision of M/NEMS devices is disclosed. The disclosed system includes analyzing one or more (force or energy) parameters associated with noise acting on a M/NEMS device, and then applying a counter force to the M/NEMS. As demonstrated in the Examples provided herein, the counter force reduces, and in some cases, eliminates the effects of the noise acting on the M/NEMS.

In some configurations of the instant application, one or more of the types of noise acting on the M/NEMS may be a noise-induced mechanical vibration of a component of the M/NEMS. For example, in an AFM system, a cantilever may be affected by noise-induced mechanical vibrations which can negatively impact the precision of microscale and nanoscale readings relating to displacement, amplitude, frequency, and or potential energy, for example. According to the systems and methods disclosed herein, however, the noise-induced mechanical vibrations (or various parameters or characteristics thereof) may be detected (or sensed), for example, by an electrostatic sensor (exemplified as reference numeral 120 in FIG. 1). In one exemplary embodiment, an electrostatic sensor comprises a comb drive placed in proximity to the M/NEMS. Illustrative comb drives are shown in U.S. Pat. No. 7,721,587, for example, the disclosure of which is hereby expressly incorporated by reference in its entirety. For example, in one configuration, the comb drive may be positioned such that it touches or is rigidly mounted to a cantilever at a position near the tip, or touches another micro-AFM device, affected by noise.

Additionally, according to the system and method disclosed herein, a counter force (or energy) is applied to the M NEMS in order to reduce or counter-act the noise acting on the M/NEMS. For example, an electrostatic actuator (exemplified as reference numeral 122 in FIG. 1) may be placed in proximity to, touching or mounted to, the M/NEMS or a specific component of the M/NEMS. In some configurations, the specific component of the M NEMS in which the electrostatic actuator is placed in proximity to is the same component which the electrostatic sensor is placed in proximity to. Exemplary electrostatic actuators include a comb drive, as illustrated in the above-incorporated U.S. Pat. No. 7,721,587, and a piezoelectric sensor and actuator, for example. In some configurations of the instant system and method, a single comb drive may be used to both detect the noise acting on the M/NEMS and apply the counter force.

Upon applying the counter force, the effects (on the M/NEMS) created by the noise is reduced or eliminated. For example, in one configuration of the instant system and method, application of the counter force (or energy) to an AFM device, causes noise-induced resonant amplitude of the cantilever to be reduced or eliminated, thereby diminishing the background reading of parameters such as amplitude, frequency, energy, etc, and increasing the detection precision of the AFM device in regard to those parameters.

Although described herein as detecting noise, and applying a counter force to a component of a M NEMS, embodiments in which noise-induced forces are detected across an entire system are possible. Further, counter force may be applied to the entire system as well. It should also be understood, the while M/NEMS devices have been exemplified herein as an AFM, the principles and concepts disclosed herein are also applicable to all forms of M/NEMS devices used in measuring parameters of a sample.

While this disclosure has been described as having exemplary designs and configurations, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

### EXAMPLES

The following non-limiting Examples illustrate various features and characteristics of the present disclosure, which is not to be construed as limited thereto.

### Example 1

### Reduction of Noise-Induced Vibrations in Microscale and Nanoscale Systems with Electrostatic Force Feedback

I. Introduction.

The aim of the present example disclosed herein was to evaluate the effect of electrostatic force feedback on noise-induced vibrations acting on M/NEMS'systems.

II. Methods and Materials.

A microscale AFM, having a micro-cantilever, was utilized in the instant example. The effective stiffness of the micro-cantilever was calculated to be 7×10⁻⁴ Nm with a mass of 9×10⁻¹² kg. The temperature was also measured to be 300K. It should be understood that the smaller the stiffness value of the micro-cantilever, the larger the amplitude.

Based on quantum statistical mechanics, the expected potential energy in the micro-cantilever is equal to the thermal energy temperature, given by the formula: ½k(x)²=½k_{B}T, where k is the stiffness, k_{B}=1.38×10⁻²³ JK (Boltzmann constant), T is the temperature, and x is the displacement amplitude of oscillation. As such, the expected inherent noise affecting the displacement of the micro-cantilever comprises amplitude of approximately 3 nm. Such amplitude, being produced by background noise, limits the resolution of the AFM to about 30 silicon atoms (6 nm), which is generally not sufficient for molecular scale manipulation.

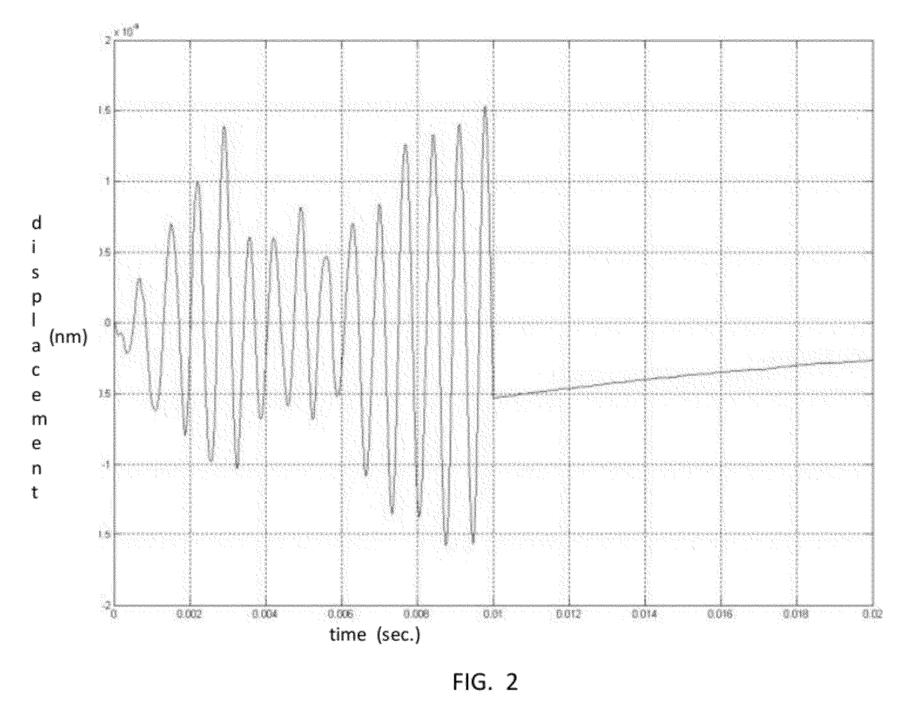

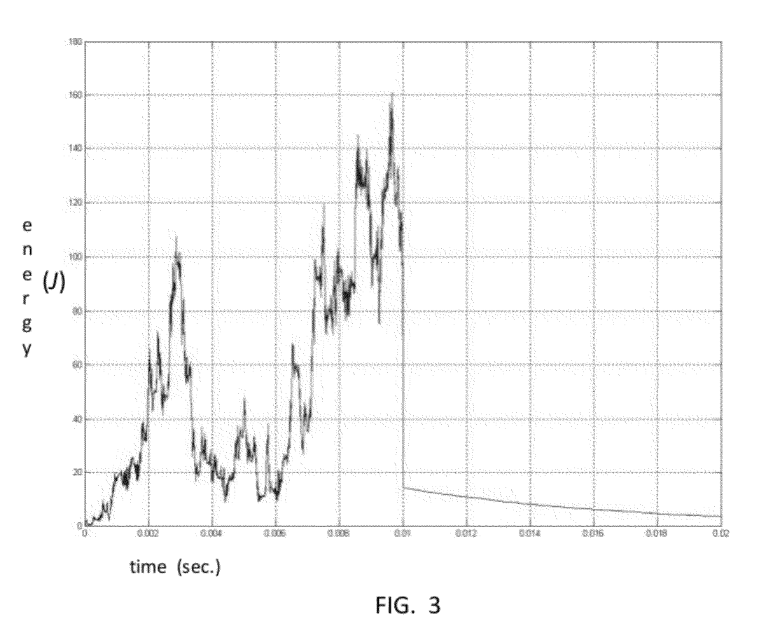

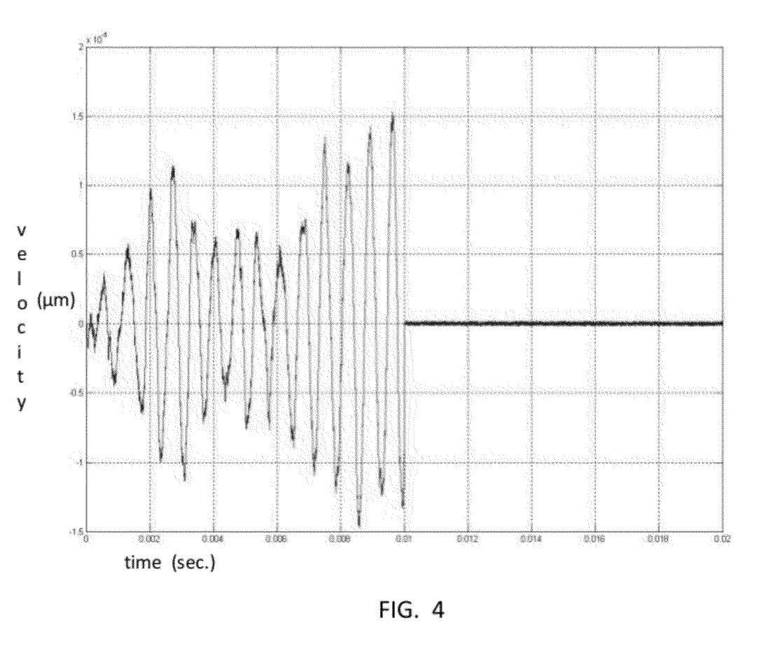

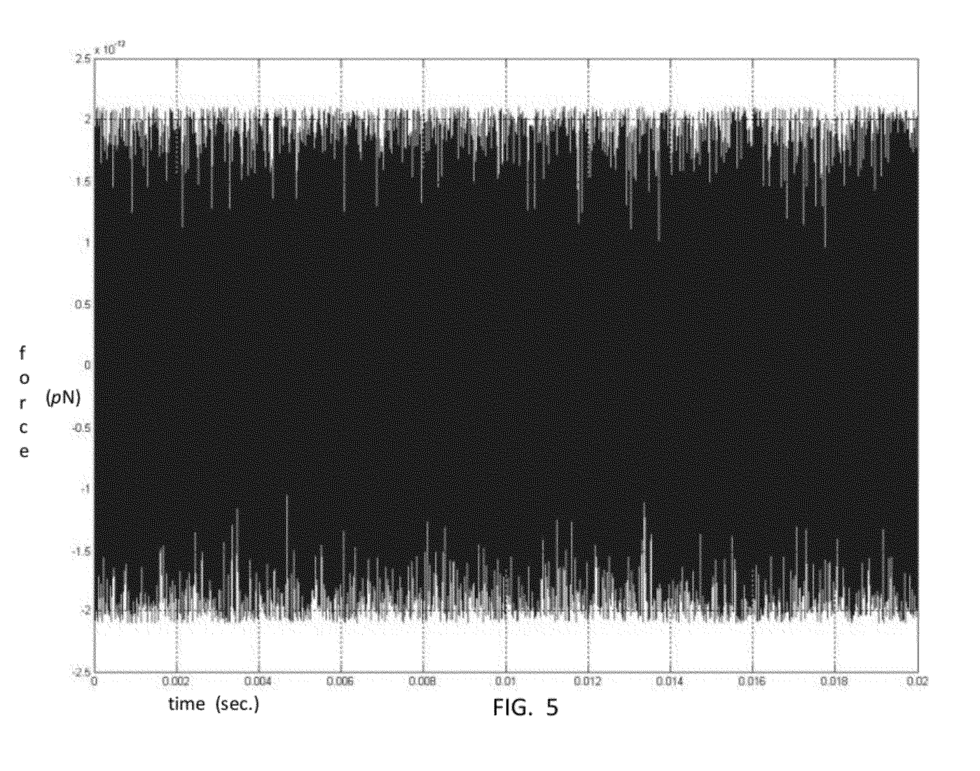

Demonstrating this point, white noise (FIG. 5) was applied, such that it acts on the instant AFM. An electrostatic sensor actuator, in the form of a comb drive, was placed (attached) at a single position along the micro-cantilever (at a position of the cantilever proximal the tip). As demonstrated in FIGS. 2-4, the AFM approaches its resonant frequency as predicted based on quantum statistical mechanics.

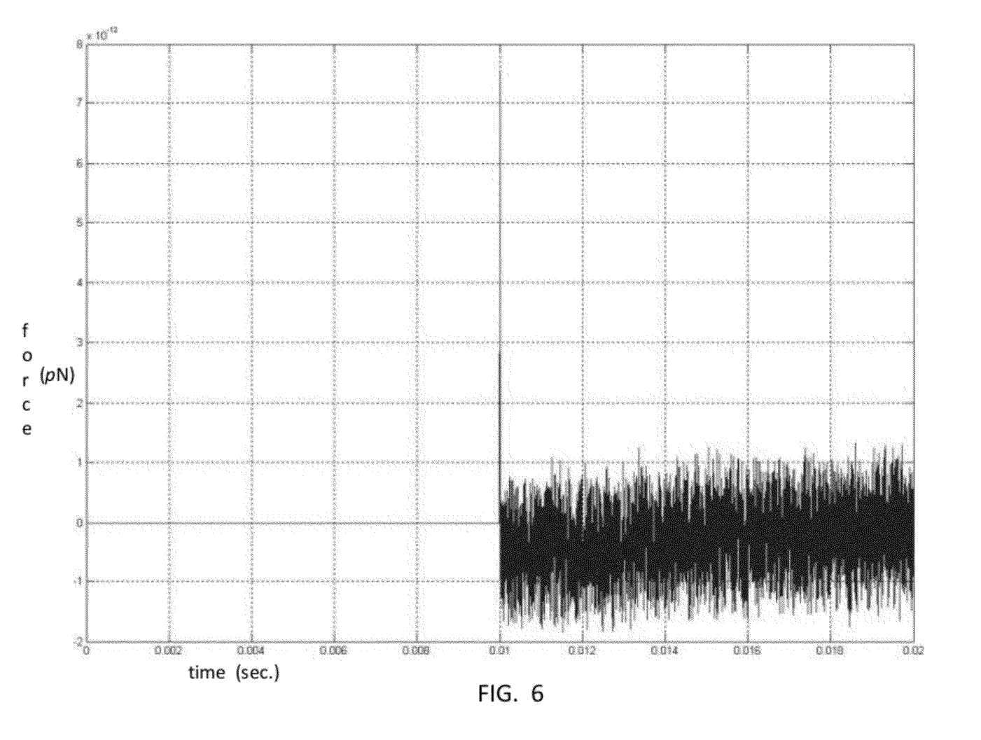

As explained above, using the comb drive, noise-induced vibrations (which may be inherent characteristics of the cantilever) were electrically sensed (using an electrostatic sensor) at a position along the cantilever. A counter electrostatic force (in the form of white noise) was fed back, or applied, to the same location of the cantilever at approximately the half-way point of the experiment (FIG. 6). As the data presented herein demonstrates, the applied counter force reduced the noise-induced resonant amplitude detected by the comb drive in the form of displacement, energy, and velocity.

III. Results and Conclusions.

Referring to FIGS. 2-6, preliminary data from the instant Example is provided. As these results demonstrate, a counter electrostatic force feedback, applied halfway through the duration of the simulation, significantly reduced the noise-induced resonant amplitude, as well as energy and velocity associated with vibrations of the cantilever, created by the applied white noise. Further, as the results in FIGS. 2-4 demonstrate, in view of time points of application of white noise (FIG. 5) and counter electrostatic force feedback (FIG. 6), the reduction in the noise-induced resonant amplitude, energy, and velocity (of the cantilever) is specific to the application of the counter force feedback.

What is claimed is:

1. A method of improving precision of an electromechanical system for analyzing a parameter of a sample, the electromechanical system comprising a plurality of components, the method comprising the steps of:
determining a first parameter of a first force associated with noise of a component of the electromechanical system;
applying a second force to a component of the electromechanical system to reduce the noise of a component; and
analyzing the parameter of the sample with the electromechanical system.

2. The method according to claim 1, wherein the electromechanical system is a nanoscale system.

3. The method according to claim 1, wherein the electromechanical system is a microscale system.

4. The method according to claim 1, wherein the electromechanical system comprises at least one of a force sensor and a displacement sensor.

5. The method according to claim 1, wherein the electromechanical system is an atomic force microscope comprising a cantilever having a tip.

6. The method according to claim 5, wherein the cantilever is the component having the noise.

7. The method according to claim 6, wherein the cantilever is the component to which the second force is applied.

8. The method according to claim 1, wherein the component having the noise and the component to which the second force is applied are the same component.

9. The method according to claim 1, wherein the first parameter comprises at least one of frequency and amplitude.

10. The method according to claim 9, wherein the second force comprises a second parameter, the second parameter also comprising the at least one of frequency and amplitude of the first parameter, the second parameter being substantially equal to the first parameter.

11. The method according to claim 1, wherein the step of determining comprises using an electrostatic sensor to sense the first force.

12. The method according to claim 1, wherein the second force comprises random white noise.

13. An electromechanical system for analyzing a parameter of a sample, the system comprising:
a plurality of components;
means for sensing a first parameter of a first force associated with noise of a component of the electromechanical system; and
means for applying a second force to a component of the electromechanical system to reduce the noise of a component.

14. The system of claim 13, wherein the electromechanical system is an atomic force microscope comprising a cantilever having a tip.

15. The system of claim 14, wherein the cantilever is the component having the noise.

16. The system of claim 13, wherein the component having the noise and the component to which the second force is applied are the same component.

17. The system of claim 13, wherein the second force comprises random white noise.

18. The system of claim 13, wherein the first parameter comprises at least one of frequency and amplitude.

19. The system of claim 13, wherein the second parameter also comprises the at least one of frequency and amplitude of the first parameter, the second parameter being substantially equal to the first parameter.

20. The system of claim 13, wherein the means for sensing comprises an electrostatic sensor.
